(19) United States
(12) Patent Application Publication
(10) Pub. No.: US 2008/0239085 A1
(43) Pub. Date: Oct. 2, 2008

(54) Apparatus that Supports Electronic Viewfinding

(75) Inventor: Wido Kruijtzer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,269

(22) PCT Filed: Apr. 26, 2005
(86) PCT No.: PCT/IB05/51348

§ 371 Date: Oct. 25, 2006

(30) Foreign Application Priority Data
Apr. 29, 2004 (EP) 04101845.8

(51) Int. Cl. H04N 5/228

(52) U.S. Cl. 348/222.1; 348/E05.031

(57) ABSTRACT

An apparatus with camera function supports electronic viewfinding. An image sensor (100, 102) of the apparatus is manually directed at a scene. Exploratory images obtained from the image sensor (100, 102) are electronically processed, to generate an indication signal that is indicative of whether a content of the exploratory images satisfies a predetermined criterion that tests for imaging of a predetermined type of subject within the boundaries of the exploratory image. The image sensor (100, 102) is manually redirected until the indication signal indicates that the exploratory image satisfies the predetermined criterion. A further handling operation is applied selectively to a captured image that is obtained when the image sensor (100, 102) has been redirected so that the indication signal indicates that the exploratory image satisfies the predetermined criterion.

The invention relates to an apparatus with an image sensor, which supports electronic viewfinding, and a method of capturing an image using electronic viewfinding.

Many human operated apparatuses contain image sensors to support a camera function. Traditionally image sensors have been used in dedicated video camera's, or CAMcorders wherein a camera is combined with a recorder. However image sensors are now also applied in mobile phones, snapshot camera's etc. In theory images sensors could also be used to give a camera function to any other type of human carried “apparatus”, such as pens, clothes, shoes, briefcases etc.

However, a human operated apparatus with a camera function typically requires a viewfinder that enables the human operator to direct the camera. Conventionally an optical eyepiece aligned with the camera is used for this purpose, through which the human camera operator looks at the scene that will be imaged. Increasingly electronic image display screens are used for this purpose, which show an image derived from the image sensor that captures the image. Typically, a small liquid crystal display screen is used for this purpose.

Both the implementation of viewfinders as optical eyepieces and display screens imposes various constraints on apparatuses. Such view finders often take considerable space and may contribute significantly to the cost of the apparatus. In the case of a display screen, power consumption by the apparatus can be significantly increased by the display screen.

Among others, it is an object of the invention to provide for an apparatus with a human operated camera function, which supports viewfinding without requiring an image display element such as an electronic display screen or an eyepiece.

The apparatus according to the invention is set forth in claim 1. According to the invention the apparatus is provided with an image sensor and an image processing circuit for testing whether the image from the image sensor meets a predetermined criterion, such as a criterion that corresponds to detection whether or not a face is present within the image. When the user activates the apparatus to operate as a camera and the image processing circuit subsequently detects that the image satisfies the criterion, the image processing circuit triggers an indication signal that may be for example a humanly perceptible signal (e.g. a sound or an indicator light) to alert the human operator that the apparatus is properly directed. The indication signal is not an image signal by which a display can be controlled to display the image; typically the indication signal contains substantially less information than such an image signal. As an alternative the triggered indication signal may cause automatic capture and storage or transmission of an image. Thus, the human user is enabled to direct the camera without recourse to a display screen or an eyepiece. The invention may be applied both to snap-shot functions, wherein an individual image is captured in response to the signal and to video filming, wherein the signal serves to make it possible to keep the camera directed at a subject.

Any suitable type of criterion may be used. A face detection technique is disclosed for example in an article titled “Face Detection in Color Images” by Rein-Lien Hsu, Mohamed Abdel-Mottaleb and Anil K. Jain published in IEEE Trans. Pattern Analysis and Machine Intelligence, vol. 24, no. 5, pp. 696-706, May 2002. The image processing circuit may be arranged to use this technique to detect the presence of a face within an image.

However, the invention is not limited to this technique, or indeed to the use of face detection. In a further embodiment the image processing circuit is arranged to apply a selectable one of a plurality of different criteria for detecting different kinds of objects in the image. Thus the user may first select the subject of the image before aiming the camera and waiting for the signal that the camera image contains the selected type of subject.

Typically, the apparatus is human portable with the image sensor fixed at a predetermined orientation with respect to the apparatus, so that a human user can direct the image sensor at any subject by changing the orientation of the apparatus as a whole. However, in another embodiment the image sensor may be directed at the subject by orienting it relative to the apparatus. In this case the apparatus need not be portable.

These and other objects and advantageous aspects of the invention will be described in terms of examples of embodiments using the following FIGURE.

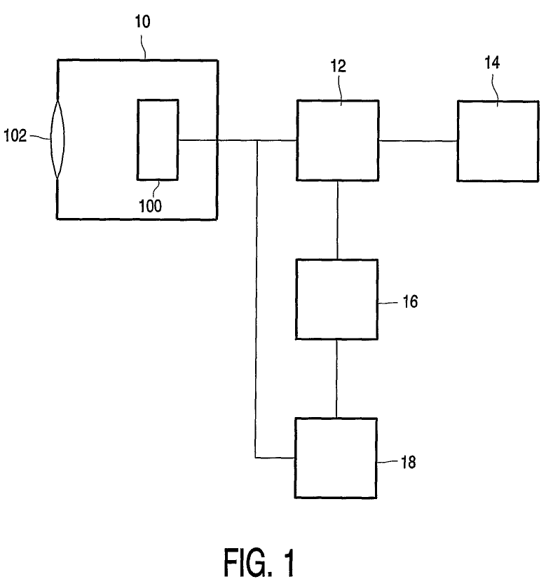

FIG. 1 shows an apparatus with a camera function

FIG. 1 shows and apparatus with a camera function. The apparatus contains an image sensor 10, an image processing circuit 12, an indicator 14 and a capture control actuator 16. In addition, a further circuit 18 is provided. Image sensor 10 typically contains a CCD chip 100 with optics 102 for imaging a scene, from a space at a distance in front of the sensor, onto chip 100. Typically fixed focus optics are used that substantially focus objects from infinity to a minimum focus distance, but an adjustable focus distance may be used as well. Indicator is for example a LED light, or a sound output device. Further circuit 18 is for example a circuit that implements a mobile telephone function, or an image storage function etc.

Image sensor 10 has an image signal output coupled to image processing circuit 12, which has an output coupled to indicator 14. Actuator 16 has an output coupled to image processing circuit 12 and further circuit 18. Further circuit 18 has an input coupled to the image signal output of image sensor 10.

In operation, when a human user wants to obtain one or more images of a subject, the user actuates actuator 16, which is implemented for example as a button on the apparatus. In response, image processing circuit 12 receives an image from image sensor 10 and tests whether the image meets a predetermined criterion. If so, image processing circuit 12 triggers indicator 14 to generate a humanly perceptible indication signal. When the user next actuates actuator 16 further circuit 18 responds by capturing an image from image sensor and by using that image for some predetermined purpose, such as transmission via a mobile telephone network, or storage in a non-volatile memory.

It will be appreciated that, without deviating from the invention, image processing circuit 12 may continuously test the criterion on incoming images, generation of the signal by indicator 14 being enabled by actuation of actuator 16.

Image processing circuit 12 may be implemented as a suitably programmed processor or dedicated hardware. Any suitable criterion may be implemented. For example a technique for detecting a face in an image is disclosed in an article titled “Face Detection in Color Images” by Rein-Lien Hsu, Mohamed Abdel-Mottaleb and Anil K. Jain published in IEEE Trans. Pattern Analysis and Machine Intelligence, vol. 24, no. 5, pp. 696-706, May 2002. This technique detects skin colored patches in the image and detects face candidates where these patches occur in a required spatial arrangement. A region in the image is assigned to the face candidate on the basis of the location of the patches involved with the face candidate and the extent of their spatial distribution. Image processing circuit 12 may be arranged to implement this technique and to trigger the signal from indicator 14 when the technique detects a face candidate with an associated region that lies within the image boundary, or, in a further embodiment, within a predetermined or user selected subregion within the image.

It should be appreciated, however, that the invention is not limited to this technique. Many other face detection techniques exist. Similarly, other techniques exist for detecting other types of subject in an image. For example, a technique may be used that detects the outline of a human form, with head, trunk, arms and legs. As other example a technique may be used that detects a page with printed text within the image boundaries, a building with walls, a roof etc. within the image boundaries, a plant with stem and leaves within the image boundaries, a car etc.

In a further embodiment a selection switch connected to image processing circuit 12 may be provided to select which of a number of available criteria should be used to trigger the signal. In this case, the user first sets the selection switch to a selected criterion and next image processing circuit 12 triggers the signal if the selected criterion is met. The user selects the criterion dependent on the type of scene that he or she wants to photograph.

Although on/off signalling from indicator 14 is used in one embodiment, it should be appreciated that more graduated signalling may be used, e.g. by varying an audio volume and/or pitch, and/or a color and/or intensity of light dependent on a position of the detected object relative to the boundaries of the image. Thus, for example, the indication signal may be varied dependent on the position of a face candidate relative to the boundaries. A first perceptible signal may for example be output if the face candidate is incomplete because part of it may lie outside the image boundary, a second, differently perceptible signal being output if the face candidate lies wholly within the boundaries of the image. Alternatively, or in addition, the perceptible signal may be perceptibly varied as a function of position of the face candidate from a centre of the image. This assists the user in aiming the image sensor.

Although an embodiment has been shown where actuator 16 is used both to enable signalling by indicator 14 and to trigger subsequent capture and further use by further circuit 18, it should be appreciated that the invention is not limited to this embodiment.

In a further embodiment further circuit 18 captures and uses successive images, for example as a video signal. In this case the signal from indicator 14 serves to enable the user to keep the image sensor directed at a predetermined subject. Subject detection as described in the previous embodiments may be used to trigger the signal from indicator 14. In a further embodiment, the predetermined criterion is that the captured image should not be displaced more than a predetermined distance with respect to a selected image, for example a first image in the series of successive images. For this purpose, image processing circuit 12 may be arranged to determine a difference part of the images from image sensor 10 with parts of the selected image at various displacements. As long as the displacement that leads to the least difference is below threshold image processing circuit 12 signals indicator 14 to output a first indication to confirm proper aiming of the image sensor and/or when this displacement is above the threshold a second indication is output to indicate an aiming error.

In another embodiment a signal from indicator 14 is generated for only one image in response to an actuation of actuator 16. Each time the user has directed the image sensor at a scene he or she actuates actuator 16 to capture an image and to test whether the image contains the required subject. The user may repeat this until a signal is obtained that indicates that the image contains the required subject. Only the latter image needs to be handled by further circuit 18, by storing it or transmitting it for example.

Preferably an image is further used only upon a specific actuation signal from the user to do so, for example to allow the user to wait for a subject person to smile after receiving the indication that image sensor 10 has been properly directed. But, in another embodiment further circuit 18 automatically captures and further uses the image once image processing circuit 12 signals that the predetermined criterion is met. Thus, the image is captured once the user has suitably oriented image sensor 10. In this case no humanly perceptible signal (and in fact no indicator 14) is strictly needed, only an internal electronic trigger signal is required. However, indicator 14 is still preferably present to provide a confirmation to the user that the image has been captured.

In yet another embodiment further circuit 18 automatically captures and further uses the image within a predetermined delay of, for example, between half a second and five seconds after the actuation of actuator that enables the indication by indicator 14. Thus, the user is given a predetermined time interval in which to direct image sensor 10, under guidance from indicator 14.

Further circuit 18 may perform any function. Typical functions include storage of one or more selected images from image sensor (for later viewing or printing for example) or transmission of the captured image, for example through a mobile telephone network or through the Internet. The further circuit 18 may be a mobile telephone circuit for example, arranged to input and output audio speech signals, and exchange these signals with a wireless telephone network. In this case, the sound output of the mobile telephone may be used for indicator 14. It will be understood that such a mobile telephone may include a display screen, but that this screen need not be used, or be suitable for viewfinding purposes, for example because it is directed at the subject of the image.

Although generation of a output signal for a single type of criterion indicative of the presence of a predetermined type of image content, particularly the presence of a predetermined type of object inside the boundaries, has been described, it should be understood that, without deviation from the invention the apparatus may provide for signalling of other types of conditions, such as the presence or absence of sufficient light to capture an image of sufficient quality, whether the predetermined subject is in focus etc. Criteria for detecting these conditions are known per se. However, it should be understood that in the apparatus signals for these conditions are additions or augmentations of the signal that indicates the presence of a predetermined type of image subject within the image boundaries.

Image sensor 10 may be rigidly coupled to the apparatus, so that the apparatus as a whole has to be reoriented in the three dimensional direction towards the subject, to ensure that the required subject is imaged within the image boundaries. This is easily possible for portable apparatuses such as mobile telephones. In an embodiment, image sensor 10 may even be mounted rotatably on the apparatus, so that it can be reoriented independent of the apparatus, at least over a predetermined range of orientations. Thus, an apparatus with a fixed orientation may be used.

1. An apparatus with a camera function, the apparatus comprising
an image sensor (100, 102) that is freely directable, at least over a range of orientations in space, towards a subject in that space that is imaged by the image sensor, the image sensor having an image signal output;
an image processing circuit (12) coupled to the image signal output and arranged to detect whether a content of an image sensed by the image sensor (100, 102) satisfies a predetermined criterion that tests for imaging of a predetermined type of subject within the boundaries of the image;
a signal generator unit (14) coupled to the image processing circuit (12) and arranged to generate an indication signal that is indicative of whether the image processing circuit (12) has detected that the image satisfies the predetermined criterion.

2. An apparatus according to claim 1, wherein said indication signal is a humanly perceptible signal.

3. An apparatus according to claim 2, wherein the signal generator unit (14) is arranged to adapt the indication signal dependent on a detected distance between at least one of the boundaries of the image, or a predetermined or user selected sub-region of the image and a region of the image wherein the subject of the predetermined type is detected.

4. An apparatus according to claim 1, comprising a memory for storing a selected image from the image sensor (100, 102), the apparatus being arranged to select the selected image upon or subsequent to detection that the image meets the criterion.

5. An apparatus according to claim 1, comprising a transmission circuit (18) for transmitting a selected image from the image sensor (100, 102), the apparatus being arranged to transmit the selected image upon or subsequent to detection that the image meets the criterion.

6. An apparatus according to claim 1, wherein the image processing circuit (12) is arranged to detect whether a content of an image sensed by the image sensor (100, 102) satisfies a selectable one of a plurality of predetermined criteria that test for the presence of respective predetermined types of subject within the boundaries of the image, the apparatus having a user selection input to select which of the criteria will be used to generate the indication signal.

7. An apparatus according to claim 1, comprising a human control interface arranged to control image use by means of a first actuation when followed by a second actuation, the first actuation enabling generation of the indication signal, the second actuation signal triggering a predetermined use of a selected image from the image sensor.

8. An apparatus according to claim 1, wherein said predetermined type of subject that the image processing circuit is arranged to test for is a human face.

9. An apparatus according to claim 1, wherein no display screen is provided to display any image from the image sensor.

10. An apparatus according to claim 1, wherein the apparatus is a handheld portable apparatus.

11. A method of capturing an image with an apparatus that has a camera function, the method comprising
manually directing an image sensor (100, 102) of the apparatus at a scene;
electronically processing exploratory images obtained from the image sensor (100, 102), to generate an indication signal that is indicative of whether a content of the exploratory images satisfies a predetermined criterion that tests for imaging of a predetermined type of subject within the boundaries of the exploratory image;
manually redirecting the image sensor (100, 102) until the indication signal indicates that the exploratory image satisfies the predetermined criterion;
applying a further handling operation selectively to a captured image that is obtained when the image sensor (100, 102) has been redirected so that the indication signal indicates that the exploratory image satisfies the predetermined criterion.
